(19) United States
(12) Patent Application Publication
(10) Pub. No.: US 2013/0188365 A1
(43) Pub. Date: Jul. 25, 2013

(54) OPTICAL LENS AND METHOD FOR MANUFACTURING THE SAME

(71) Applicant: Makoto Nakabayashi, Sennan-gun (JP)

(72) Inventor: Makoto Nakabayashi, Sennan-gun (JP)

(73) Assignee: SUMITOMO ELECTRIC FINE POLYMER, INC., Sennan-gun, Osaka (JP)

(21) Appl. No.: 13/825,846

(22) PCT Filed: Jun. 28, 2012
(86) PCT No.: PCT/JP2012/066539

§ 371 Date: Mar. 25, 2013

(30) Foreign Application Priority Data
Jul. 4, 2011 (JP) 2011-147902

(51) Int. Cl. G02B 1/04

(52) U.S. Cl. CPC G02B 1/041
USPC 362/335; 264/2.6

(57) ABSTRACT

The present invention relates to an optical lens made of a molded product of a resin composition obtained by nano-dispersing a thermally conductive filler in a transparent resin, a content of the thermally conductive filler being 1 wt % or more based on a weight of the molded product, and the thermally conductive filler being nano-dispersed so that a total light transmittance of 30% or more is achieved when the molded product has a thickness of 2 mm, and a method for manufacturing the same. The optical lens according to the present invention has high transparency, improved resistance to heat and aging, high surface hardness, and improved lightfastness that can meet recent demands.

### TECHNICAL FIELD

The present invention relates to an optical lens made of a resin that is used for concentration of light using a xenon lamp, an LED, a laser, or the like as a light source, and a method for manufacturing the same.

### BACKGROUND ART

Optical lenses made using transparent resins, such as transparent polyamide resins and fluororesins, have features in that they are light-weight, unlikely to break, and easily molded as compared with optical lenses made of inorganic glass, and therefore, are widely used in various types of optical equipment. An optical lens made of a resin, however, has a problem, for example, in that its optical performance tends to vary when subject to an environmental change as compared with a glass optical lens. Thus, it is required that an optical lens made of a resin have both high transparency comparable to that of a glass optical lens and the property of undergoing no change in color due to irradiation of light during use (lightfastness).

In order to meet this demand for an optical lens made of a resin, an optical lens wherein a transparent polyamide resin, a fluororesin, or the like is used as a transparent resin that forms the lens has been proposed. Japanese Patent Laying-Open No. 9-137057 (PTL 1), for example, proposes an optical lens having a high surface hardness that is composed of at least one cyclic aliphatic diamine containing 6 to 24 carbon atoms, an almost equimolar proportion of at least one aromatic dicarboxylic acid containing 8 to 16 carbon atoms, and up to 20 mol % of a polyamide-forming monomer.

Even an optical lens made using such a transparent polyamide resin, however, may undergo a change in color, deformation, aging, and the like when it is used for a light-emitting device such as a so-called strobe light that uses a xenon lamp, an LED, a blue-violet laser, or the like as a light source and has a high irradiance level. WO2009/084690 (PTL 2) discloses, as an optical lens made of a resin that undergoes little change in color, deformation, aging, and the like due to irradiation of light even when it is used as a light-emitting device that uses a xenon lamp or the like as a light source, an optical lens characterized in that it uses, for example, a condensation polymer of 1,10-decanedicarboxylic acid and 3,3′-dimethyl-4,4′-diaminodicyclohexylmethane as a transparent polyamide, it is made of a molded product of a molding material containing a stabilizer, it shows a total light transmittance of 60% or more when the molded product has a thickness of 2 mm, and the above-mentioned total light transmittance is 50% or more after irradiating the molded product kept at 80° C. with a light beam having a light intensity of 1000 W/m² for 500 hours, using a xenon lamp (claims 1, 4 and 7).

### CITATION LIST

### Patent Literature

PTL 1: Japanese Patent Laying-Open No. 9-137057
PTL 2: WO2009/084690

### SUMMARY OF INVENTION

### Technical Problem

In recent years, however, demands for the lightfastness of an optical lens used for a strobe light or the like are further increasing. That is, in recent strobe lights, an increased light intensity and shortened emission intervals are desired, and moreover, a closer distance between a light source and a lens is desired, in order to allow incorporation and miniaturization of strobe lights. When a conventional optical lens is used in a strobe light that meets such demands, foaming, a change in color, and the like may occur. Thus, an optical lens made of a resin that does not suffer from foaming or a change in color even after multiple times of irradiation at a higher light intensity has been desired.

An object of the present invention is to provide an optical lens that exhibits high transparency, and does not have a problem such as a change in color, even after multiple times of irradiation at a higher light intensity.

### Solution to Problem

The present inventor found as a result of extensive research that an optical lens made of a molding material having enhanced heat release property obtained by nano-dispersing a thermally conductive filler in a transparent resin such as a transparent polyamide exhibits improved transparency, and is unlikely to cause a problem such as a change in color, even after multiple times of irradiation at a higher light intensity.

The present invention is directed to an optical lens made of a molded product of a resin composition obtained by nano-dispersing a thermally conductive filler in a transparent resin, a content of the thermally conductive filler being 1 wt % or more based on a weight of the molded product, and the thermally conductive filler being nano-dispersed so that a total light transmittance of 30% or more is achieved when the molded product has a thickness of 2 mm.

The optical lens according to the present invention is a molded product obtained by molding a resin composition that uses a transparent resin as a matrix resin. Examples of the transparent resin include transparent resins made of acrylic resins, polycarbonates, polyolefins, fluororesins, polyamides, silicones, epoxy, polyimides, polystyrenes, polyesters, and the like. In particular, a transparent polyamide that is amorphous and has a high glass transition point as described and exemplified in WO2009/084690 (PTL 2) is suitable. Examples of such a transparent polyamide resin include a transparent polyamide resin obtained by condensation of a specific diamine and a specific dicarboxylic acid, ring-opening polymerization of lactam, or condensation of ω-aminocarboxylic acid.

Among such transparent polyamide resins, those having an aromatic ring and an aliphatic ring, for example, are preferred, and a condensation polymer of 1,10-decanedicarboxylic acid and 3,3′-dimethyl-4,4′-diaminodicyclohexylmethane, in particular, is preferred since it is unlikely to cause a change in color, deformation, and the like. In the optical lens according to the present invention, the transparent resin is preferably a condensation polymer of 1,10-decanedicarboxylic acid and 3,3′-dimethyl-4,4′-diaminodicyclohexylmethane.

A transparent resin composition, which is a molding material of the optical lens according to the present invention, has a feature in that a thermally conductive filler is nano-dispersed in the transparent resin.

The heat release property of the molded product is enhanced by dispersing the thermally conductive filler, and consequently, an increase in temperature can be suppressed even after multiple times of irradiation at a higher light intensity, and hence, a molded product having improved lightfastness (transparent resin molded product) that is unlikely to undergo a change in color or foaming can be achieved. That is, the optical lens according to the present invention has a feature in that it is unlikely to undergo a change in color or foaming even when it is used for a light-emitting device having an increased light intensity and shortened emission intervals.

The term “thermally conductive filler” herein means a filler having a thermal conductivity of 1 W/m·K or more, preferably a filler having a thermal conductivity of 20 W/m·K or more, and more preferably a filler having a thermal conductivity of 50 W/m·K or more. If the thermal conductivity is less than 1 W/m·K, improved lightfastness cannot be achieved even if an amount over 10 wt % of the filler is added to the transparent resin, and foaming or a change in color will occur after multiple times of irradiation at a higher light intensity with a xenon lamp, an LED, a laser (blue-violet), or the like.

The amount of the thermally conductive filler to be added is 1 wt % or more based on the weight of the molded product forming the lens. If the amount is less than 1 wt %, improved lightfastness cannot be achieved, and foaming or a change in color will occur after multiple times of irradiation at a higher light intensity with a xenon lamp, an LED, a laser, or the like. On the other hand, if the amount is over 50 wt %, transparency may decrease; therefore, an amount of 50 wt % or less is preferred, and an amount of 20 wt % or less is used to achieve further improved transparency. That is, a range of 1 to 20 wt % is more preferred, and within this range, both further improved lightfastness and improved transparency can be achieved.

Moreover, since the dispersion of the thermally conductive filler is a nano-dispersion, a molded product having further improved transparency can be achieved. That is, the improved transparency of the molded product forming the optical lens (transparent resin molded product) according to the present invention can be obtained by using the transparent resin as the matrix resin used in molding the optical lens, and by nano-dispersing the thermally conductive filler.

The term “nano-dispersion” means that nano-particles having an (average) particle size of 400 nm or less are dispersed well in the matrix resin (transparent resin). Therefore, the thermally conductive filler used in the present invention corresponds to particles having an (average) particle size of 400 nm or less. If the particle size is over 400 nm, the optical lens will become cloudy, and high transparency cannot be achieved.

The expression “dispersed well” means that primary particles of the filler (nano-particles) are not aggregated and secondary particles (aggregated particles) are not formed, or means a dispersed state in which an aggregate of the primary particles (aggregated particles) has a diameter of 400 nm or less. If the filler is aggregated to form an aggregate having a diameter over 400 nm, cloudiness will occur, and the transparency of the optical lens will decrease. The optical lens according to the present invention, however, can maintain improved transparency because the thermally conductive filler is nano-dispersed.

As described above, there is a strong correlation between the degree of nano-dispersion of the filler and transparency. Thus, the degree of nano-dispersion of the filler can be represented by the degree of transparency of the lens (total light transmittance). In the optical lens according to the present invention, the thermally conductive filler is nano-dispersed so that a total light transmittance of 30% or more, and preferably 70% or more, is achieved when the molded product forming the optical lens has a thickness of 2 mm. The term “total light transmittance” herein represents an index indicating transparency, is measured using the measurement method defined in JIS K 7361, and is shown as a ratio in percentage between an incident light intensity T₁ and a total light intensity T₂ that has passed through a test piece in the visible light region, specifically, the range of wavelengths of 400 to 800 nm.

Preferably, the transparent resin composition, which is the molding material of the optical lens according to the present invention, contains, in addition to the transparent resin and the thermally conductive filler, a dispersant that is liquid at a temperature 50° C. higher than a glass transition point of the matrix resin, and is obtained by mixing a dispersion in which the thermally conductive filler is nano-dispersed in this dispersant into the transparent resin. By using the method wherein the dispersion in which the thermally conductive filler is nano-dispersed in the dispersant is prepared, and then this dispersion is mixed into the transparent resin, the thermally conductive filler can be easily nano-dispersed in the transparent resin. In the optical lens according to the present invention, preferably, the resin composition contains a dispersant that is liquid at a temperature 50° C. higher than the glass transition point of the transparent resin, and is obtained by mixing the dispersion in which the thermally conductive filler is nano-dispersed in the dispersant into the transparent resin.

In the optical lens according to the present invention, the dispersant is preferably a monomer that is polymerized with a crosslinking coagent, a plasticizer, ultraviolet irradiation, or electron beam irradiation (hereinafter referred to as a UV/EB monomer).

The resin composition forming the optical lens according to the present invention can contain, in addition to the transparent resin and the thermally conductive filler, other components for enhancing various physical properties of the optical lens within a range of amounts that do not impair the gist of the present invention, and the other components include a crosslinking coagent, a plasticizer, and a UV/EB monomer. When, for example, crosslinking is performed as described below, a crosslinking coagent is preferably added to promote crosslinking.

Furthermore, when the crosslinking coagent, the plasticizer, and the UV/EB monomer are liquid at a temperature 50° C. higher than the glass transition point of the matrix resin, and the thermally conductive filler can be nano-dispersed therein, these components can be used as the dispersant for nano-dispersing the thermally conductive filler. This is preferable because the components that are preferably used in forming the optical lens can be used themselves as the dispersant, thus eliminating the need to use a component that is not particularly necessary to enhance the physical properties of the optical lens.

Examples of the crosslinking coagent that is liquid at a temperature 50° C. higher than the glass transition point of the matrix resin include triallyl isocyanurate (hereafter referred to as TAIC). TAIC has a melting point of about 23° C., and easily becomes liquid. Moreover, TAIC has excellent crosslinkablity owing to its trifunctionality, and the inclusion of TAIC is preferable in that, for example, the heat resistance (reflow heat resistance) of the optical lens can be easily enhanced by exposure to ionizing radiation, TAIC is relatively unlikely to cause a change in color due to exposure to radiation or heat, and it has low toxicity to human bodies.

Furthermore, TAIC has excellent compatibility with the transparent resin. TAIC has excellent compatibility with the transparent polyamide (in particular, a condensation polymer of 1,10-decanedicarboxylic acid and 3,3′-dimethyl-4,4′-diaminodicyclohexylmethane), for example, and can dissolve the transparent polyamide to a concentration as high as about 50 wt %. Therefore, TAIC allows a large amount of the thermally conductive filler to be easily nano-dispersed, and thus, can be suitably used as a dispersant for nano-dispersing the thermally conductive filler in the lens at a high concentration. In the optical lens according to the present invention, the dispersant is preferably TAIC.

Examples of the UV/EB monomer include acrylic monomers, methacrylic monomers, imide-based monomers, silicone-based monomers, urethane-based monomers, isocyanate-based monomers, epoxy-based monomers, and the like.

The transparent resin composition, which is the molding material of the optical lens according to the present invention, preferably contains a stabilizer in addition to the composition. When a stabilizer is included, a change in color can be suppressed more efficiently. The optical lens according to the present invention preferably further contains a stabilizer.

The term “stabilizer” as referred to herein includes all the stabilizers serving to prevent deterioration due to light, heat, and the like, and also includes an antioxidant, for example. Specific examples of the stabilizer include a hindered amine light stabilizer, a UV absorbent, a phosphorus-based stabilizer, a hindered phenol-based antioxidant, a hydroquinone-based antioxidant, and the like. Use of two or more types of stabilizers may enhance the function as a stabilizer, leading to a further improved effect.

The resin composition, which is the molding material of the optical lens according to the present invention, can further contain components other than those described above, for example, a copper inhibitor, a flame retardant, a lubricant, a conductive agent, a plating agent, and the like, within a range of amounts that do not impair the gist of the present invention.

By crosslinking the transparent resin, the optical lens can be formed into a molded product having improved heat resistance (reflow heat resistance) and rigidity at high temperature. In the optical lens according to the present invention, the transparent resin is preferably crosslinked.

This crosslinking is performed, for example, by heating the resin, or by a method wherein the resin is exposed to ionizing radiation. Among the above, the method wherein the resin is exposed to ionizing radiation is preferred in terms of easy control. An electron beam is preferred as the ionizing radiation in terms of safety, apparatus availability, and the like.

The optical lens according to the present invention preferably has a storage modulus at 270° C. of 0.1 MPa or more. When the storage modulus at 270° C. is set to 0.1 MPa or more, rigidity that is satisfying at temperatures from room temperature to high temperature can be achieved, which is preferable because, even when the optical lens is mounted by soldering using lead-free solder or by solder reflow, or even when the optical lens is used in a high-temperature environment, the problem of thermal deformation is unlikely to occur, and so-called reflow heat resistance is high. An optical lens having high rigidity at high temperature, as with the optical lens according to the present invention, can be obtained by crosslinking the transparent resin having the composition of the molding material as described above.

The term “storage modulus” herein is one term (actual number term) constituting a complex modulus representing the relation between a stress produced when a sinusoidal vibration strain is given to a viscoelastic body and the strain, and is a value measured with a viscoelasticity measuring device (DMS). More specifically, the storage modulus is a value measured with the viscoelasticity measuring device, DVA-200, manufactured by IT Keisoku Seigyo Corporation, at a heating rate of 10° C./min from room temperature (25° C.).

The optical lens according to the present invention can be manufactured by molding, into a lens, the resin composition containing the transparent resin, the thermally conductive filler that is nano-dispersed in the transparent resin, and other components that may optionally be added, and by crosslinking the resin, preferably after molding. With the method wherein crosslinking is performed after molding, molding is easily performed because the resin composition (molding material) has low rigidity before crosslinking, and heat resistance and rigidity can be enhanced by crosslinking, thus resulting in an optical lens having improved heat resistance and rigidity at high temperature.

The resin composition containing the transparent resin, the thermally conductive filler that is nano-dispersed in the transparent resin, and other components that may optionally be added can be preferably prepared by the method wherein, as described above, a dispersion is prepared by nano-dispersing the thermally conductive filler in a dispersant that is liquid at a temperature 50° C. higher than the glass transition point of the matrix resin, for example, in a crosslinking coagent, a plasticizer, or a UV/EB monomer, and the resulting dispersion is mixed into the transparent resin (optionally containing other components such as a stabilizer). Alternatively, the resin composition can be prepared by a method wherein a dispersion is prepared by nano-dispersing the thermally conductive filler in a dispersant that is liquid at a temperature 50° C. higher than the glass transition point of the matrix resin, and the resulting dispersion is mixed with a monomer forming the transparent resin (optionally containing other components such as a stabilizer) and a polymerization initiator to polymerize the monomer.

The present inventor found that the thermally conductive filler can be nano-dispersed in the transparent resin by dispersing the thermally conductive filler in the dispersant, and adding the dispersant in which the thermally conductive filler is dispersed while stirring a mixture principally containing the transparent resin or a mixture principally containing the monomer forming the transparent resin.

In addition to the method described above, that is, “the method wherein a dispersion obtained by nano-dispersing the thermally conductive filler in the dispersant is mixed into the transparent resin or the raw material monomer thereof”, examples of the method of nano-dispersing the thermally conductive filler in the composition of the transparent resin may also include the following methods:

1) a method wherein the resin is melted, and the thermally conductive filler is added and dispersed therein by shearing force or the like; and

2) a method wherein the thermally conductive filler is treated with a surface-treating agent such as a silane coupling agent, a surfactant, or the like, and then the treated thermally conductive filler is dispersed in the resin.

In view of the easiness of nano-dispersion, however, it is preferred to use the above-described method, that is, “the method wherein a dispersion obtained by nano-dispersing the thermally conductive filler in the dispersant is mixed into the transparent resin or the monomer thereof”, or use the above-described method in combination with the method 1) and/or the method 2). When these methods are used in combination, dispersibility can be further enhanced.

The present invention is directed to a method for manufacturing an optical lens including the steps of molding a resin composition obtained by nano-dispersing a thermally conductive filler in a transparent resin, and crosslinking the transparent resin after the step of molding. With this manufacturing method, an optical lens having improved heat resistance (reflow heat resistance) and rigidity at high temperature can be easily achieved.

### Advantageous Effects of Invention

The optical lens according to the present invention exhibits high transparency, and is unlikely to undergo a change in color and the like even after multiple times of irradiation with light at a higher intensity, using a light source such as a xenon lamp, an LED, a laser (blue violet), or the like. The optical lens according to the present invention having improved heat resistance (reflow heat resistance) and rigidity at high temperature can be easily manufactured by the method for manufacturing an optical lens according to the present invention.

### DESCRIPTION OF EMBODIMENTS

Embodiments for carrying out the present invention will be described next.

The present invention, however, is not limited to the embodiments described herein.

As described above, the transparent resin forming the molding material of the optical lens according to the present invention is preferably a transparent polyamide. Examples of the transparent polyamide may include a transparent polyamide exemplified in WO2009/084690 (PTL 2), for example; however, so long as the compound itself is transparent, the transparent polyamide may be a compound containing a plurality of different polyamides, and may contain a crystalline polyamide. The transparent polyamide may also be a transparent polyamide manufactured by performing the synthesis reaction (polymerization) together with the raw material monomer, in the presence of the stabilizer, reinforcing agent, and the like described below.

A commercially available product may also be used as the transparent polyamide. For example, a polyamide made of a condensation polymer of 1,10-decanedicarboxylic acid and 3,3′-dimethyl-4,4′-diaminodicyclohexylmethane is commercially available under the tradename Grilamide TR-90 (EMS-CHEMIE (Japan) Ltd.) or the like.

Examples of other specific commercial products of the transparent polyamide used in the present invention include Trogamid CX7323, Trogamid T, and Trogamid CX9701 (tradenames, all from Daicel-Degussa, Ltd.); Grilamid TR-155, Grivory G21, Grilamid TR-55LX, and Grilon TR-27 (all from EMS-CHEMIE (Japan) Ltd.); Cristamid MS1100 and Cristamid MS1700 (all from Arkema, Ltd.); and Sealer 3030E, Sealer PA-V2031, and Isoamide PA-7030 (all from DuPont, Ltd.).

Examples of the thermally conductive filler may include alumina, (crystalline) silica, aluminum nitride, boron nitride, silicon nitride, zinc oxide, tin oxide, magnesium oxide, silicon carbide, carbon materials such as carbon black, carbon fiber, and carbon nanotubes, synthetic magnesite, and the like. The thermally conductive filler may not necessarily be spherical in shape, and may also be a bar-shaped, plate-shaped, or ground filler. Furthermore, these thermally conductive fillers may be subjected to surface treatment, for example, with a surfactant or the like, for facilitating the nano-dispersion.

A preferred range of proportions of the stabilizer that can be added to the optical lens according to the present invention is not particularly limited; however, as the proportion becomes larger, an optical lens that is more unlikely to undergo a change in color and the like due to irradiation with a xenon lamp or the like can be achieved. On the other hand, if the proportion is excessively large, problems such as blooming, deterioration of the clouding point (haze), and decreased transmittance will occur. Thus, generally, when one type of stabilizer is used, it is preferably used in an amount of about 0.01 to 5 wt parts based on 100 wt parts of the transparent polyamide.

A commercially available product may be used as the stabilizer. For example, hindered amine light stabilizers are commercially available as ADK STAB LA68, LA62 (tradenames, Asahi Denka, Ltd.), and the like, UV absorbents are commercially available as ADK STAB LA36 (tradename, Asahi Denka, Ltd.) and the like, phosphorus-based stabilizers are commercially available as Irgafos 168 (tradename, BASF, Ltd.) and the like, hindered phenolic antioxidants are commercially available as Irganox 245, Igranox 1010 (tradenames, BASF, Ltd.), and the like, and hydroquinone-based antioxidants are commercially available as Methoquinone (tradename: Seiko Chemical Corporation) and the like, and any of these products may be used.

Examples of the crosslinking coagent that can be used in the present invention include, other than TAIC, oximes such as p-quinonedioxime, p,p′-dibenzoylquinonedioxime, and the like; acrylates or methacrylates such as ethylene dimethacrylate, polyethylene glycol dimethacrylate, trimethylol propane trimethacrylate, cyclohexyl methacrylate, acrylic acid/zinc oxide mixture, allyl methacrylate, trimethacryl isocyanurate, and the like; vinyl monomers such as divinylbenzene, vinyltoluene, vinylpyridine, and the like; allyl compounds such as hexamethylene diallyl nadimide, diallyl itaconate, diallyl phthalate, diallyl isophthalate, diallyl monoglycidyl isocyanurate, triallyl cyanurate, and the like; maleimide compounds such as N,N′-m-phenylene-bis-maleimide, N,N′-(4,4′-methylenediphenylene)dimaleimido, and the like. TAIC and these crosslinking coagents may be used alone or in combination.

When TAIC is used as the crosslinking coagent, the content is preferably less than 25 wt parts, and more preferably 1 to 20 wt parts, based on 100 wt parts of the transparent polyamide. As the TAIC content increases, crosslinking is promoted to increase the effect of enhancing the reflow heat resistance and the like. However, if the content is over the above-described range, hardening may become too slow to cause decreased moldability, making it difficult to achieve a good appearance of the molded product.

In the manufacture of the optical lens according to the present invention, examples of mixers used in mixing the transparent resin, the dispersion in which the thermally conductive filler is nano-dispersed, the optionally added components, and the like include known mixers, for example, a single-screw extruder, a twin-screw extruder, a pressurizing kneader, and the like. Preferred among the above is a twin-screw extruder, and generally, a kneading temperature of about 230° C. to 300° C. and a kneading time of about 2 seconds to 15 minutes are preferably adopted.

The molding method in the molding step is not particularly limited, and examples of molding methods include injection molding, injection compression molding, press molding, extrusion, blow molding, vacuum molding, and the like, but the injection molding method is preferred in view of the easiness and precision of molding.

### EXAMPLES

The present invention will be described next based on the Examples. It is noted that the present invention is not limited to the Example described herein, and can be modified into other embodiments so long as the gist of the present invention is not impaired. The raw materials used in the Example and Comparative Examples will be listed first.

[Transparent polyamide] a condensation polymer of 1,10-decanedicarboxylic acid and 3,3′-dimethyl-4,4′-diaminohexylmethane (tradename: Grilamid TR-90, EMS-CHEMIE (Japan) Ltd.)
[Crosslinking coagent] triallyl isocyanurate (TAIC: Nippon Kasei Chemical Co., Ltd.) [Thermally conductive filler] titanium oxide (tradename: TTO-51 A, Ishihara Sangyo Kaisha, Ltd.)

### Example

A resin composition having the composition shown in Table 1 was obtained as follows. TAIC and the thermally conductive filler were mixed in a mill to obtain a mixture. This mixture was side-fed into a twin-screw mixer (TEM58BS, Toshiba Machine Co., Ltd.) and mixed with the transparent polyamide. The resin composition thus obtained was injection-molded using SE-18 (electric injection molding machine, Sumitomo Heavy Industries, Ltd.) to prepare a molded product sample having dimensions of 40 mm×40 mm×2 mm (thickness). Injection molding was performed under the following conditions: a resin temperature of 280° C., a mold temperature of 80° C., and a cycle of 30 seconds.

The resulting molded product sample was irradiated with an electron beam of 300 kGy for crosslinking. The sample after irradiation was measured for its total light transmittance and its appearance after a lightfastness test, in the manners described below. These results are shown in Table 1.

### Comparative Example 1

In accordance with the composition shown in Table 1, TAIC was side-fed into a twin-screw mixer (TEM58BS, Toshiba Machine Co., Ltd.) and mixed with the transparent polyamide. Then, the resulting mixture was injection-molded using SE-18 (electric injection molding machine, Sumitomo Heavy Industries, Ltd.) under the following conditions as in the Example to prepare a molded product sample having dimensions of 40 mm×40 mm×2 mm (thickness). Furthermore, the resulting molded product sample was irradiated with an electron beam under the same conditions as in the Example for crosslinking, and the sample after irradiation was measured for its total light transmittance and its appearance after a lightfastness test, in the manners described below. These results are shown in Table 1.

### Comparative Example 2

In accordance with the composition shown in Table 1, TAIC, the thermally conductive filler, and the transparent polyamide were fed from the top of a twin-screw mixer (TEM58BS, Toshiba Machine Co., Ltd.) and mixed. Then, the resulting mixture was injection-molded using SE-18 (electric injection molding machine, Sumitomo Heavy Industries, Ltd.) under the same conditions as in the Example to prepare a molded product sample having dimensions of 40 mm×40 mm×2 mm (thickness). Furthermore, the resulting molded product sample was irradiated with an electron beam under the same conditions as in the Example for crosslinking, and the sample after irradiation was measured for its total light transmittance and its appearance after a lightfastness test, in the manners described below. These results are shown in Table 1.

[Total Light Transmittance]

Total light transmittance was measured pursuant to JIS K 7361. The ratio between the incident light intensity T₁ and the total light intensity T₂ that has passed through the test piece within the visible light region (the range of wavelengths of 400 to 800 nm) is shown in percentage.

[Appearance after Lightfastness Test]

Using a commercially available external strobe light (Nikon Corporation), flashing under the following conditions was repeated 200 cycles, in a cycle of once in 10 seconds or once in 2 seconds, with a distance between the surface of a lens sample and a light source (xenon lamp) being set to 2 mm.

flashing time: ( 1/800) second, color temperature: 5600 K

Change in color of the lens after 200 cycles was evaluated, and the evaluation result is shown in Table 1, in which A indicates that no change in color was observed in the lens, and B indicates that the lens underwent a change in color in its central portion.

TABLE 1

| | | | Compar- | Compar- |
|---|---|---|---|---|
| | | | ative | ative |
| | | | Example | Example |
| | | Example | 1 | 2 |
| Resin | Transparent Polyamide: TR-90 | 100 | 100 | 100 |
| Compo- | Crosslinking Coagent: TAIC | 15 | 15 | 15 |
| sition | Thermally Conductive Filler: | 10 | 0 | 10 |
| | TTO-51A | | | |
| Total Light Transmittance (%) | | 80 | 90 | 20 |
| Appear- | Flashing: Once in 10 Sec | A | A | A |
| ance after | Flashing: Once in 2 Sec | A | B | B |
| Light- | | | | |
| fastness | | | | |
| Test | | | | |

As is clear from the results shown in Table 1, the molded product of the Example exhibited excellent transparency (a total light transmittance of 80%) and excellent lightfastness. On the other hand, the molded product according to Comparative Example 1 not containing a thermally conductive filler exhibited excellent transparency (a total light transmittance of 90%), but had low lightfastness and underwent a change in color after 200 cycles of flashing in the cycle of once in 2 seconds. It is believed that the molded product had low heat release property and underwent a change in color due to heat because no thermally conductive filler was dispersed therein. Moreover, it is believed that the molded product according to Comparative Example 2, which contained the thermally conductive filler, but was prepared by being mixed into the resin without being dispersed in TAIC, had low transparency (a total light transmittance of 20%), and thus, the thermally conductive filler was not nano-dispersed therein. Furthermore, the molded product also had low lightfastness, and underwent a change in color after 200 cycles of flashing in the cycle of once in 2 seconds.

### INDUSTRIAL APPLICABILITY

The optical lens according to the present invention can be suitably used for applications such as a lens for a strobe light (for example, a Fresnel lens for a strobe light).

1. An optical lens made of a molded product of a resin composition obtained by nano-dispersing a thermally conductive filler in a transparent resin, a content of said thermally conductive filler being 1 wt % or more based on a weight of said molded product, and said thermally conductive filler being nano-dispersed so that a total light transmittance of 30% or more is achieved when said molded product has a thickness of 2 mm.

2. The optical lens according to claim 1, wherein
said transparent resin is a condensation polymer of 1,10-decanedicarboxylic acid and 3,3′-dimethyl-4,4′-diaminodicyclohexylmethane.

3. The optical lens according to claim 1, wherein
said resin composition contains a dispersant that is liquid at a temperature 50° C. higher than a glass transition point of said transparent resin, and is obtained by mixing a dispersion in which said thermally conductive filler is nano-dispersed in said dispersant into said transparent resin.

4. The optical lens according to claim 3, wherein
said dispersant is a monomer that is polymerized with a crosslinking coagent, a plasticizer, ultraviolet irradiation, or electron beam irradiation.

5. The optical lens according to claim 3, wherein
said dispersant is triallyl isocyanurate.

6. The optical lens according to claim 1, further comprising a stabilizer.

7. The optical lens according to claim 1, wherein
said transparent resin is crosslinked.

8. The optical lens according to claim 1, wherein
a storage modulus at 270° C. is 0.1 MPa or more.

9. A method for manufacturing an optical lens comprising the steps of molding a resin composition obtained by nano-dispersing a thermally conductive filler in a transparent resin, and crosslinking said transparent resin after said step of molding.
